(19) United States
(12) Patent Application Publication
(10) Pub. No.: US 2020/0045359 A1
(43) Pub. Date: Feb. 6, 2020

(54) REPRODUCTION DEVICE, GENERATION DEVICE, REPRODUCTION SYSTEM, PROGRAM, RECORDING MEDIUM

(71) Applicant: SHARP KABUSHIKI KAISHA, Sakai City, Osaka (JP)

(72) Inventor: YASUAKI TOKUMO, Sakai City, Osaka (JP)

(73) Assignee: SHARP KABUSHIKI KAISHA, Sakai City, Osaka (JP)

(21) Appl. No.: 16/499,648

(22) PCT Filed: Mar. 28, 2018
(86) PCT No.: PCT/JP2018/012999

§ 371 Date: Sep. 30, 2019

(30) Foreign Application Priority Data
Apr. 4, 2017 (JP) 2017-074534

(51) Int. Cl. H04N 21/435; H04N 21/462; H04N 21/218; H04N 5/268

(52) U.S. Cl. CPC H04N 21/435; H04N 21/462; H04N 21/845; H04N 5/268; H04N 21/21815

(57) ABSTRACT

A reproduction device (100) includes a first obtaining unit (1100) configured to obtain metadata including multiple resource locator groups, a second obtaining unit (1110) configured to obtain a piece of partial video data from a location indicated by the metadata, and a reproduction unit (120) configured to reproduce a partial video indicated by the piece of partial video data obtained by the second obtaining unit (1110).

### TECHNICAL FIELD

The present invention relates to a reproduction device, a generation device, a reproduction system, a program, a recording medium, and a generation method.

### BACKGROUND ART

In recent years, there has been a focus on technologies for reproducing omnidirectional video that is capable of all-around viewing from a certain view point in a virtual space. Such a technology includes a technique using a camera capable of capturing omnidirectional images, or a technique using multiple cameras to capture videos and joining together the videos captured by the cameras.

For example, PTL 1 discloses a technique for converting, based on images captured by multiple cameras and location information, the captured images into view-point conversion images to generate a video as viewed from a prescribed virtual view point.

In recent years, various techniques for delivering contents such as video images have been developed. An example of the technique for delivering contents is Dynamic Adaptive Streaming over HTTP (DASH), which Moving Picture Experts Group (MPEG) is now making effort to standardize. The DASH includes a definition of a format for metadata such as Media Presentation Description (MPD) data.

### CITATION LIST

### Patent Literature

PTL 1: JP 2013-106324 A (published on May 30, 2013)

### SUMMARY OF INVENTION

### Technical Problem

Against such a background, there is a demand for a technique capable of generating and transmitting metadata related to an omnidirectional video and reproducing the omnidirectional video, based on the metadata.

However, even though techniques related to capturing an omnidirectional video are disclosed, no techniques are known that concern how to generate and transmit metadata related to an omnidirectional video and how to reproduce the omnidirectional video, based on the metadata.

In light of the above problems, an object of the present invention is to achieve a technique for generating and transmitting metadata related to an omnidirectional video and reproducing the omnidirectional video, based on the metadata.

### Solution to Problem

In order to accomplish the above-described object, a reproduction device according to an aspect of the present invention is a reproduction device for reproducing content data delivered in the form of multiple pieces of time division data by time division, the multiple pieces of time division data including one or more partial video data groups, each of the one or more partial video data groups including a piece of partial video data at least either for a view point or for a line-of-sight direction, the piece of partial video data being a part of multiple pieces of partial video data constituting an omnidirectional video, the reproduction device including: a first obtaining unit configured to obtain metadata including multiple resource locator groups, each of the multiple resource locator groups including a resource locator for specifying a location of each of the multiple pieces of partial video data included in the one or more partial video data groups; a second obtaining unit configured to obtain each of the multiple pieces of partial video data from the location indicated by the metadata; and a reproduction unit configured to reproduce a partial video indicated by each of the multiple pieces of partial video data obtained by the second obtaining unit.

In order to accomplish the above-described object, a generation device according to an aspect of the present invention is a generation device for generating metadata to be referenced by a reproduction device for reproducing content data delivered in the form of multiple pieces of time division data by time division, the multiple pieces of time division data including one or more partial video data groups, each of the one or more partial video data groups including a piece of partial video data at least either for a view point or for a line-of-sight direction, the piece of partial video data being a part of multiple pieces of partial video data constituting an omnidirectional video, the generation device including a metadata generating unit configured to generate the metadata including multiple resource locator groups, each of the multiple resource locator groups including a resource locator for specifying a location of each of the multiple pieces of partial video data included in the one or more partial video data groups.

In order to accomplish the above-described object, a reproduction system according to an aspect of the present invention is a reproduction system for reproducing content data to be time-divided into multiple pieces of time division data for delivery, the multiple time division data including one or more partial video data groups, each of the one or more partial video data groups including a piece of partial video data at least either for a view point or for a line-of-sight direction, the piece of partial video data being a part of multiple pieces of partial video data constituting an omnidirectional video, the reproduction system including: a metadata generating unit configured to generate metadata including multiple resource locator groups, each of the multiple resource locator groups including a resource locator for specifying a location of each of the multiple pieces of partial video data included in the one or more partial video data groups; a first obtaining unit configured to obtain the metadata including the multiple resource locator groups, each of the multiple resource locator groups including the resource locator for specifying the location of each of the multiple pieces of partial video data included in the one or more partial video data groups; a second obtaining unit configured to obtain each of the multiple pieces of partial video data from the location indicated by the metadata; and a reproduction unit configured to reproduce a partial video indicated by each of the multiple pieces of partial video data obtained by the second obtaining unit.

In order to accomplish the above-described object, a reproduction method according to an aspect of the present invention is a reproduction method for reproducing content data to be time-divided into multiple pieces of time division data for delivery, the multiple pieces of time division data including one or more partial video data groups, each of the one or more partial video data groups including a piece of partial video data at least either for a view point or for a line-of-sight direction, the piece of partial video data being a part of multiple pieces of partial video data constituting an omnidirectional video, the reproduction method including the steps of: obtaining metadata including multiple resource locator groups, each of the multiple resource locator groups including a resource locator for specifying a location of each of the multiple pieces of partial video data included in the one or more partial video data groups; obtaining each of the multiple pieces of partial video data from the location indicated by the metadata; and reproducing a partial video indicated by each of the multiple pieces of partial video data obtained in the step of obtaining each of the multiple pieces of partial video data.

### Advantageous Effects of Invention

According to an aspect of the present invention, a technique can be established that involves generating and transmitting metadata related to an omnidirectional video and reproducing the omnidirectional video, based on the metadata.

### BRIEF DESCRIPTION OF DRAWINGS

FIG. 1 is a block diagram illustrating a configuration of a main part of a reproduction system according to Embodiment 1 of the present invention.

FIG. 2 is a diagram illustrating a general configuration of a reproduction system according to Embodiment 1 of the present invention.

FIG. 3 is a diagram illustrating an example of metadata included in content data to be reproduced by the reproduction system according to Embodiment 1 of the present invention.

FIG. 4 is a diagram illustrating an example of metadata included in content data to be reproduced by the reproduction system according to Embodiment 1 of the present invention.

FIGS. 5A and 5B are diagrams for illustrating an example of reproduction of partial videos in a recommended viewing mode of the reproduction system according to Embodiment 1 of the present invention.

FIG. 6 is a flowchart illustrating a flow of generation processing of a generation device in the reproduction system according to Embodiment 1 of the present invention.

FIG. 7 is a flowchart illustrating a flow of reproduction processing of a reproduction device in the reproduction system according to Embodiment 1 of the present invention.

FIG. 8 is a block diagram illustrating a configuration of a main part of a reproduction system according to Embodiment 2 of the present invention.

FIGS. 9A and 9B are diagrams illustrating an example of metadata related to switching of a viewing mode included in metadata referenced by the reproduction system according to Embodiment 2 of the present invention.

FIGS. 10A and 10B are diagrams illustrating an example of metadata related to switching of the viewing mode included in the metadata referenced by the reproduction system according to Embodiment 2 of the present invention.

FIG. 11 is a diagram illustrating an example of metadata related to switching of the viewing mode included in the metadata referenced by the reproduction system according to Embodiment 2 of the present invention.

FIG. 12 is a flowchart illustrating a flow of reproduction processing of a reproduction device in the reproduction system according to Embodiment 2 of the present invention.

FIG. 13 is a flowchart illustrating a flow of switching processing of the reproduction device in the reproduction system according to Embodiment 2 of the present invention.

FIG. 14 is a block diagram illustrating a configuration of a main part of a reproduction system according to Embodiment 3 of the present invention.

FIGS. 15A and 15B are diagrams for illustrating a partial video constituting an omnidirectional video reproduced by the reproduction system according to Embodiment 3 of the present invention.

### DESCRIPTION OF EMBODIMENTS

### Embodiment 1

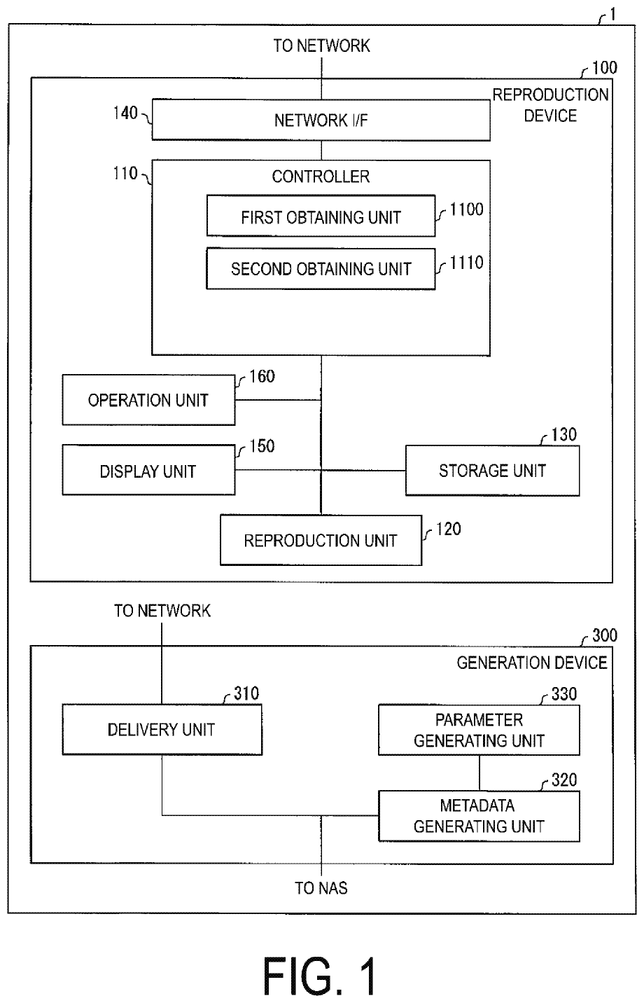

A reproduction system 1 according to the present embodiment will be described with reference to FIGS. 1 to 8.

### Reproduction System 1

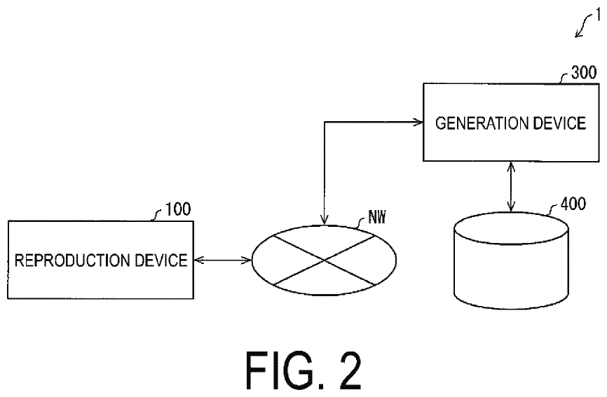

FIG. 1 is a diagram illustrating a reproduction system 1 according to the present embodiment, and FIG. 2 is a diagram illustrating a general configuration of the reproduction system 1 according to the present embodiment.

As illustrated in FIG. 2, the reproduction system 1 is a system including a reproduction device 100, a generation device 300, and a network storage server (NAS) 400. The reproduction device 100 and the generation device 300 are connected to the Internet NW.

The reproduction device 100, the generation device 300, and the NAS 400 will be described below.

### Reproduction Device 100

The reproduction device 100 reproduces content data time-divided into multiple time division data for delivery. In other words, the reproduction device 100 configures an omnidirectional video, and reproduces, for a prescribed period of time, each partial video indicated by partial video data included in the time division data.

As illustrated in FIG. 1, the reproduction device 100 includes a controller 110, a reproduction unit 120, a storage unit 130, a network I/F 140, a display unit 150, and an operation unit 160.

Note that the reproduction device 100 may include a display unit displaying partial videos reproduced by the reproduction unit 120 described below. In such a configuration, a head-mounted display includes the reproduction device 100, and the reproduced partial videos can be presented to a user via the display unit 150.

In another example, the reproduction unit 120 may be configured to supply the partial video data to be reproduced, to the display unit 150 provided separately from the reproduction device 100. In such a configuration, the head-mounted display includes the display unit 150, and the reproduced partial videos can be presented to the user via the display unit 150.

### Controller 110

The controller 110 receives a partial video reproduction indication from the user via the operation unit 160, and then receives, from the generation device 300, metadata related to the partial videos to be reproduced. The controller 110 references the metadata to identify resource locators for reproducing the partial video. The controller 110 causes the reproduction unit 120 to reference a period of time for reproducing the partial videos to be reproduced and the resource locators, and to reproduce the partial videos.

Thus, the controller 110 is capable of reproducing the omnidirectional video based on the metadata related to the omnidirectional video.

Here, the above-described partial videos may be, for example, media segments specified in Dynamic Adaptive Streaming over HTTP (DASH). The above-described metadata may be, for example, Media Presentation Description (MPD) data specified in the DASH and related to the content data described above. An example of the resource locator may be the URL of a media segment. An example of each of the resource locator groups may be each of the AdaptationSets specified in the DASH.

As illustrated in FIG. 1, the controller 110 functions as a first obtaining unit 1100 and a second obtaining unit 1110.

### First Obtaining Unit 1100

The first obtaining unit 1100 obtains metadata including multiple resource locator groups including resource locators specifying the locations of partial video data.

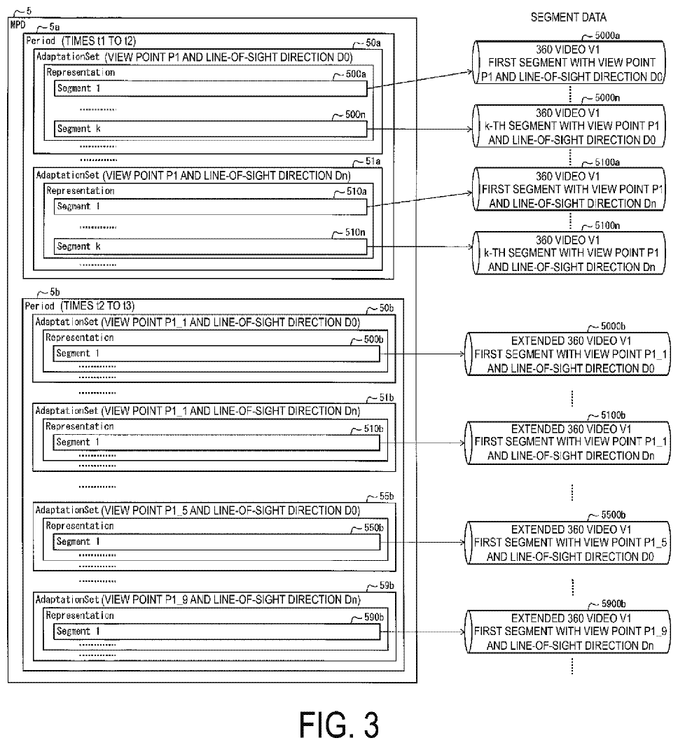

Hereinafter, the first obtaining unit 1100 will be described in more detail using FIG. 3.

FIG. 3 is a diagram illustrating an example of metadata included in content data to be reproduced by the reproduction system 1 according to Embodiment 1 of the present invention.

In the example illustrated in FIG. 3, MPD data 5 includes at least time division data Period 5a at times t1 to t2 and time division data Period 5b at times t2 to t3. The Period 5a and Period 5b include partial video data groups for each different view point and each different line-of-sight direction, the partial video data groups being included in the partial video data. The partial video data group includes multiple AdaptationSets (resource locator groups) 50a, 51a, 50b, 51b, 55b, and 59b including resource locators (URLs) specifying locations of partial video data.

Here, in the example illustrated in FIG. 3, in the Period 5a, AdaptationSet 50a and 51a differ from each other in the line-of-sight direction of segment data indicated by the resource locators (URLs) of Segments included in the AdaptationSet. Similarly, in the Period 5b, AdaptationSets 50b, 51b, 55b, and 59b differ from one another in at least one of the view point and the line-of-sight direction of segment data indicated by the resource locators (URLs) of Segments included in the AdaptationSet.

Thus, in FIG. 3, in the time division data related to at least a prescribed period of time, each of the resource locator groups includes no resource locators corresponding to the same view point or line-of-sight direction as that for the resource locators in the other resource locator groups. According to such a configuration, the reproduction device 100 of the reproduction system 1 can reproduce the partial videos in a free viewing mode (first reproduction mode) in which the user, while moving, freely switches the view point or the line-of-sight direction for viewing.

Functions of each of the members of the reproduction system 1 in a case that the reproduction system 1 is constantly in the free viewing mode will be described below.

### Second Obtaining Unit 1110

The second obtaining unit 1110 obtains partial video data from the locations indicated by the metadata.

The second obtaining unit 1110 first detects the location and line-of-sight direction of the user in a virtual space coordinate system. The location of the user can be detected by a known location information obtaining unit such as any of various sensors and a GPS. The second obtaining unit 1110 identifies a view point determined by the location of the user. The line-of-sight direction of the user can be detected by an accelerated sensor or the like provided in the head-mounted display.

The second obtaining unit 1110 selects, from one or more resource locator groups, a resource locator group corresponding to the view point and the line-of-sight direction of the user.

Thus, the second obtaining unit 1110 can sequentially obtain, by referencing the resource locator group, resource locators (URLs) including information related to the view point and line-of-sight direction corresponding to the location and line-of-sight direction of the user. With reference to the URLs, the second obtaining unit 1110 can obtain data of the partial videos according to the view point and line-of-sight direction corresponding to the location and line-of-sight direction of the user.

### Reproduction Unit 120

The reproduction unit 120 reproduces the partial videos indicated by the partial video data obtained by the second obtaining unit 1110.

For example, as illustrated in FIG. 3, the reproduction unit 120 reproduces partial videos indicated by partial video data 5000a, 5000n, 5100a, 5100n, and the like at times t1 to t2. Here, as illustrated in FIG. 3, the partial video data at t1 to t2 are the segment data of the first to k-th segments of the view point P1 and line-of-sight direction D0, . . . view point P1 and line-of-sight direction Dn of a 360 video V1.

Here, the “360 video” means an omnidirectional video viewed by looking all around from a certain view point in a virtual space.

That is, in the example described above, the reproduction unit 120 reproduces the 360 video V1 corresponding to a view taken in line-of-sight directions D0 to Dn from a view point P1 in the virtual space at times t1 to t2.

Here, as described above, in the present embodiment, the reproduction unit 120 reproduces the partial videos in the free viewing mode. For example, in FIG. 3, in each of the AdaptationSets for times t1 to t2, the line-of-sight directions (D0 to Dn) at the view point P1 are assigned to different partial video data. Similarly, in each of the AdaptationSets for times t2 to t3, view points (P1_1 to P1_9) or the line-of-sight directions (D0 to Dn) are assigned to different partial video data.

Thus, the reproduction unit 120 reproduces the 360 video V1 corresponding to the views taken in different line-of-sight directions from the view point P1 such that, in a case that the user wearing the head-mounted display looks all around, the view follows changes in the line-of-sight direction of the user. As a result, in a case that the user looks all around, the reproduction unit 120 may allow the user to take a 360-degree view from the view point P1.

As illustrated in FIG. 3, the reproduction unit 120 reproduces the partial videos indicated by the partial video data 5000b, 5100b, 5500b, 5900 b, and the like at times t2 to t3. Here, as illustrated in FIG. 3, the partial video data at t2 to t3 are the segment data of the first through k-th Segments with the view point P1_1 and line-of-sight direction D0, . . . , the view point P1_1 line-of-sight direction Dn, . . . , the view point P1_5 and line-of-sight direction D0, . . . , and the view point P1_9 and line-of-sight direction Dn of extended 360 video.

Here, the “extended 360 video” means an omnidirectional video viewed by looking all around from view points within a prescribed range based on one point in the virtual space.

That is, in the example described above, the reproduction unit 120 reproduces an extended 360 video V1 viewed by looking around in the line-of-sight direction D0 to Dn from the view points P1_1 to P1_9 within the prescribed range based on the view point P1 at times t2 to t3. That is, in a case that the user looks around, the reproduction unit 120 allows the user to take a 360-degree view from the view points P1_1 to P1_9.

Here, the view points P1_1 to P1_9 at prescribed distances from the view point P1 are assumed to be positioned at only small distances from the view point P1. In this case, the reproduction unit 120 can achieve reproduction with even small changes in the view point of the user reflected in the partial video. Thus, the reproduction system 1 may improve reality achieved in a case that the user wearing the head-mounted display views the extended 360 video V1. In a case that the view points P1_1 to P1_9 are positioned at long distances from the view point P1, the reproduction unit 120 can provide partial videos at various angles to the user viewing the extended 360 video V1. The view point and line-of-sight direction will be described below in detail.

### Storage Unit 130

The storage unit 130 is a storage medium for buffering partial video data (segment data) indicated by resource locators specifying the locations of partial video data to be reproduced, and storing metadata related to the partial video data to be reproduced.

### Network I/F 140

The network I/F 140 transmits and/or receives data to/from the generation device 300.

### Display Unit 150

The display unit 150 is a display displaying the partial videos to be reproduced.

### Operation Unit 160

The operation unit 160 is an operation panel on which the user provides indications to the reproduction device 100.

### Generation Device 300

Now, the generation device 300 according to the present embodiment will be described. The generation device 300 generates metadata referenced by the reproduction device 100, reproducing content data time-divided into multiple time division data for delivery, and delivers the generated metadata to the reproduction device 100.

As illustrated in FIG. 1, the generation device 300 includes a delivery unit 310, a metadata generating unit 320, and a parameter generating unit 330.

### Delivery Unit 310

The delivery unit 310 receives a request for metadata from the reproduction device 100, and then delivers, to the reproduction device 100, the latest metadata recorded in the NAS 400 at that point in time.

Thus, the delivery unit 310 can transmit the metadata related to the omnidirectional video.

### Metadata Generating Unit 320

The metadata generating unit 320 generates metadata including multiple resource locator groups including resource locators specifying the locations of partial video data.

Specifically, the metadata generating unit 320 generates MPD data 5 including the multiple AdaptationSets 50a, 51a, 50b, 51 b, 55b, 59b, and the like in FIG. 3.

Accordingly, the metadata generating unit 320 can generate metadata related to the omnidirectional video.

Here, as illustrated in FIG. 3, the metadata generating unit 320 generates metadata indicating that the partial videos belong to the 360 video or the extended 360 video V1.

The metadata generating unit 320 delivers, to the reproduction device 100, the metadata generated using the AdaptationSets. By receiving and referencing the metadata, the reproduction device 100 can reproduce the video while switching the view point and line-of-sight direction of the 360 video or the extended 360 video for each Period. For example, as illustrated in FIG. 3, the metadata generating unit 320 may generate time division data Period 5a related to the 360 video and time division data Period 5b related to the extended 360 video.

The metadata generating unit 320 generates metadata for a free viewing mode in which the user freely switches, while moving, the view point or the line-of-sight direction for viewing, or metadata for a recommended viewing mode in which the user views, without moving, a video with a view point recommended by a content producer. In a case of generating metadata for the free viewing mode, the metadata generating unit 320 provides, to the metadata, a parameter group related to a free view point and a free line-of-sight direction generated by the parameter generating unit 330, as well as the resource locators (URLs) indicating the partial video data. In a case of generating metadata in the recommended viewing mode, the metadata generating unit 320 provides the parameter group for the recommended view point and recommended line-of-sight direction generated by the parameter generating unit 330, as well as the resource locators (URLs) indicating the partial video data to the metadata.

### Parameter Generating Unit 330

The parameter generating unit 330 generates various parameters to be referenced by the metadata generating unit 320 to generate metadata.

For example, the parameter generating unit 330 generates, for each AdaptationSet illustrated in FIG. 3, a parameter group related to the view point and the line-of-sight direction. Thus, as illustrated in FIG. 3, the metadata generating unit 320 can provide, to the metadata (MPD data), parameters related to the view point and the line-of-sight direction generated by the parameter generating unit 330.

### NAS 400

The NAS 400 is a network storage holding metadata and each partial video data.

### Modified Example of Embodiment 1

In the example described above, the reproduction system 1 is constantly in the free viewing mode, and generates and transmits metadata related to the omnidirectional video and reproduces the omnidirectional video, based on the metadata. However, the present embodiment is not limited to this. Even in a case of being constantly in the recommended viewing mode (second reproduction mode), the reproduction system 1 can also generate and transmit metadata related to the omnidirectional video and reproduce the omnidirectional video, based on the metadata.

Here, the recommended viewing mode is a viewing mode in which the user views, without moving, the video with the view point recommended by the content producer, and a certain resource locator group included in the multiple resource locator groups includes resource locators corresponding to the same view point or the same line-of-sight direction as that for the resource locators included in other resource locator groups.

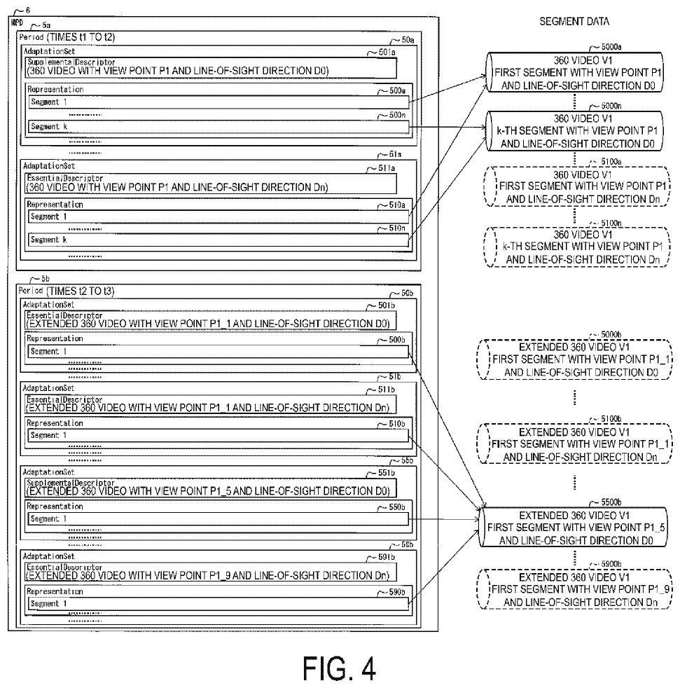

Now, the metadata for the recommended viewing mode will be specifically described using FIG. 4. FIG. 4 is a diagram illustrating an example of metadata included in content data to be reproduced by the reproduction system 1 according to Embodiment 1 of the present invention.

As illustrated in FIG. 4, at times t1 to t2, both a Segment 500a in the AdaptationSet 50a and a Segment 510a in the AdaptationSet 51a are associated with partial video data (segment data) 5000a, which is the first segment with the view point P1 and line-of-sight direction D0. Similarly, a Segment 500n in the AdaptationSet 50a and a Segment 510n in the AdaptationSet 51a are both associated with partial video data (segment data) 5000n, which is the k-th segment with the view point P1 and line-of-sight direction D0. At times t2 to t3, a Segment 500b in the AdaptationSet 50b, a Segment 510b in the AdaptationSet 51b, a Segment 550b in the AdaptationSet 55b, and a Segment 590b in the AdaptationSet 59b are associated with partial video data (segment data) 5500b, which is the first segment with the view point P1_5 and line-of-sight direction D0.

In this way, in the recommended viewing mode, the Segments and the partial video data are associated with one another in a many-to-one relationship.

Thus, even in a case that a content is reproduced that includes multiple types of videos such as, the 360 video and the extended 360 video, the use of the metadata as described above can allow the user to view the video using the view point and line-of-sight direction recommended by the content producer. Even without movement of the user, the reproduction device 100 of the reproduction system 1 can allow the user to view the video using the view point and line-of-sight direction recommended by the content producer.

### Metadata Related to Viewpoint and Line-of-Sight Direction

Now, metadata related to the view point and line-of-sight direction and used in a case of selecting the recommended viewing mode will be specifically described using FIG. 4.

SupplementalDescriptors 501a and 551b are added to the AdaptationSets 50a and 55b in FIG. 4, respectively. SupplementalDescriptors 501a and 551b include parameter groups related to the view point P1 and line-of-sight direction D0 and the view point P1_5 and line-of-sight direction D0, respectively, which are the recommended view points and line-of-sight directions. Thus, the SupplementalDescriptor included in the AdaptationSet includes the parameter group related to the recommended view point and line-of-sight direction.

EssentialDescriptor 511a, 501b, 511b, and 591b are added to the AdaptationSets 51a, 50b, 51b, and 59b in FIG. 4, respectively. The EssentialDescriptors 511a, 501b, 511b, and 591b includes parameter groups related to the view point P1 and line-of-sight direction Dn, the view point P1_1 and line-of-sight direction D0, view point P1_1 and line-of-sight direction Dn, and the view point P1_9 and line-of-sight direction Dn, respectively. Thus, the EssentialDescriptor included in the AdaptationSet includes the parameter group related to, for example, the data other than the recommended view point and line-of-sight direction.

The SupplementalDescriptors and EssentialDescriptors as described above are generated by the parameter generating unit 330 of the generation device 300. The metadata generating unit 320 provides SupplementalDescriptor and EssentialDescriptor data to the generated metadata. For example, as illustrated in FIG. 4, the metadata generating unit 320 delivers the metadata with the SupplementalDescriptor or EssentialDescriptor information to the reproduction device 100 for each AdaptationSet.

The first obtaining unit 1100 of the reproduction device 100 obtains, from the SupplementDescriptors 501a and 551b, the parameter group related to the recommended view point and line-of-sight direction, and the resource locators (URLs) indicating the partial video data. The first obtaining unit 1100 obtains, from the EssentialDescriptors 511a, 501b, 511b, and 591b, the parameter group related to the view points and line-of-sight directions other than the recommended view point and line-of-sight direction, and the resource locators (URLs) indicating the partial video data.

Thus, the partial video data obtained by the second obtaining unit 1110 are as illustrated in FIG. 4. In other words, for the Period 5a, the partial video data 5000a to 5000n are obtained, which correspond to the first to k-th segments with the view point P1 and line-of-sight direction D0. For the Period 5b, the partial video data are obtained that follow the partial video data 5500b, corresponding to the first segment with the view point P1_5 and line-of-sight direction D0.

Here, the AdaptationSet with the above-described SupplementalDescriptor added may be utilized by a 360-video-incompatible device or by an extended-360-video-incompatible device. That is, even in 360 video or extended 360-video-incompatible devices, and the like, it is possible to reference to AdaptationSet to which SupplementalDescriptor is added, and thus obtain the parameter group related to the recommended view point and line-of-sight direction, and the resource locators (URLs) indicating the partial video data. As a result, 360-video-incompatible devices or the like can preferably reproduce videos of the content producer's recommended view point and line-of-sight direction.

Note that the metadata related to the view point and line-of-sight direction used in a case of selecting the recommended viewing mode is not limited to the SupplementalDescriptor and EssentialDescriptor described above. To the extent that the recommended viewing mode as described above can be implemented, the reproduction system 1 can use metadata related to arbitrary view point and line-of-sight direction.

### Example of Reproduction of Partial Video in Recommended Viewing Mode

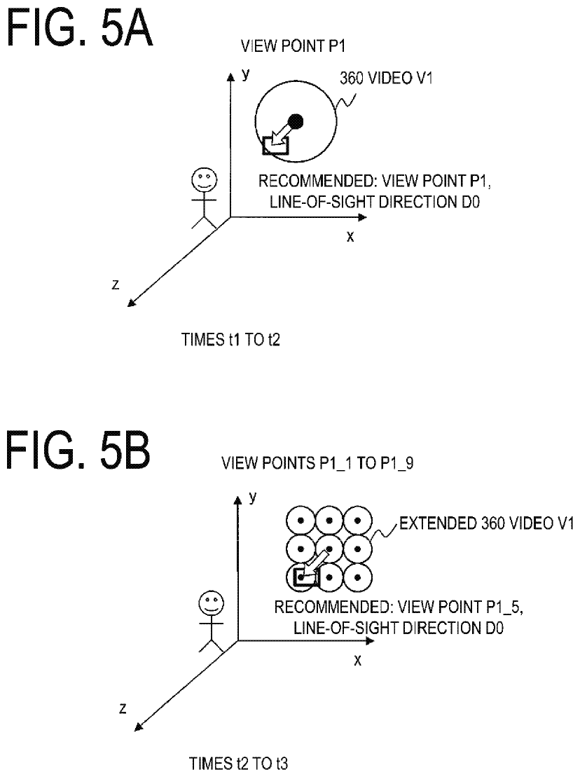

Now, an example of reproduction of the partial videos using the MPD data in the recommended viewing mode of the reproduction system 1 will be described with reference to FIGS. 5A and 5B.

FIGS. 5A and 5B are diagrams for illustrating the example of reproduction of the partial videos using the MPD data in the recommended viewing mode of the reproduction system 1. In other words, FIGS. 5A and 5B are diagrams for illustrating the partial videos reproduced in a case that the reproduction system 1 references the MPD data 6 illustrated in FIG. 4.

As illustrated in FIG. 4, for times t1 to t2 (Period 5a), the partial video data 5000a to 5000n with the view point P1 and line-of-sight direction D0 are recommended. This is schematically illustrated in FIG. 5A. As illustrated in FIG. 5A, at times t1 to t2, the reproduction unit 120 of the reproduction device 100 reproduces the partial video in the line-of-sight direction D0 from the view point P1, included in the 360 video V1. This means that, even in a case of changing the line-of-sight direction while wearing the head-mounted display, the user views, in all line-of-sight directions, the partial video with the line-of-sight direction D0 from the view point P1.

As illustrated in FIG. 4, for times t2 to t3 (Period 5b), the partial video with the view point P1_5 and line-of-sight direction D0 is recommended. This means that, even in a case of changing the line-of-sight direction while wearing the head-mounted display, the user views, in all the line-of-sight directions, the partial video with the line-of-sight direction D0 from the view point P1_5.

Accordingly, since the reproduction system 1 utilizes the MPD data in the recommended viewing mode, the reproduction system 1 can allow the user to view the partial video with a particular line-of-sight direction recommended by the content producer regardless of movement of the user (changes in the view point and line-of-sight direction).

As illustrated in FIGS. 5A and 5B, at least one of the recommended view point and line-of-sight direction of the reproduction system 1 may change at time t2. In this case as well, the reproduction system 1 can allow the user to view the partial videos recommended by the content producer without moving.

### Generation Processing

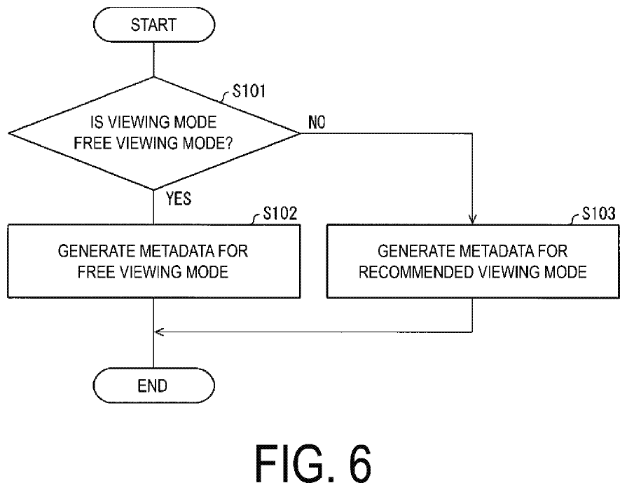

Now, the generation processing of the generation device 300 of the reproduction system 1 according to the present embodiment will be described with reference to FIG. 6. FIG. 6 is a flowchart illustrating a flow of generation processing of the generation device 300 of the reproduction system 1 according to the present embodiment.

Step S101: As illustrated in FIG. 6, the metadata generating unit 320 of the generation device 300 first determines whether to select the free viewing mode or the recommended viewing mode. Selection of the free viewing mode (step S101, YES) causes the processing to proceed to step S102. Selection of the recommended viewing mode (step S101, NO) causes the processing to proceed to step S103.

Step S102: selection of the free viewing mode causes the metadata generating unit 320 of the generation device 300 to generate metadata for the free viewing mode. In other words, the metadata generating unit 320 of the generation device 300 generates, for example, MPD data 5 as illustrated in FIG. 3. The metadata generating unit 320 of the generation device 300 generates metadata for the free viewing mode and then terminates the generation processing.

Step S103: Selection of the recommended viewing mode causes the metadata generating unit 320 of the generation device 300 to generate metadata for the recommended viewing mode. In other words, the metadata generating unit 320 of the generation device 300 generates, for example, MPD data 6 as illustrated in FIG. 4. The metadata generating unit 320 of the generation device 300 generates metadata for the recommended viewing mode, and then terminates the generation processing.

### Reproduction Processing

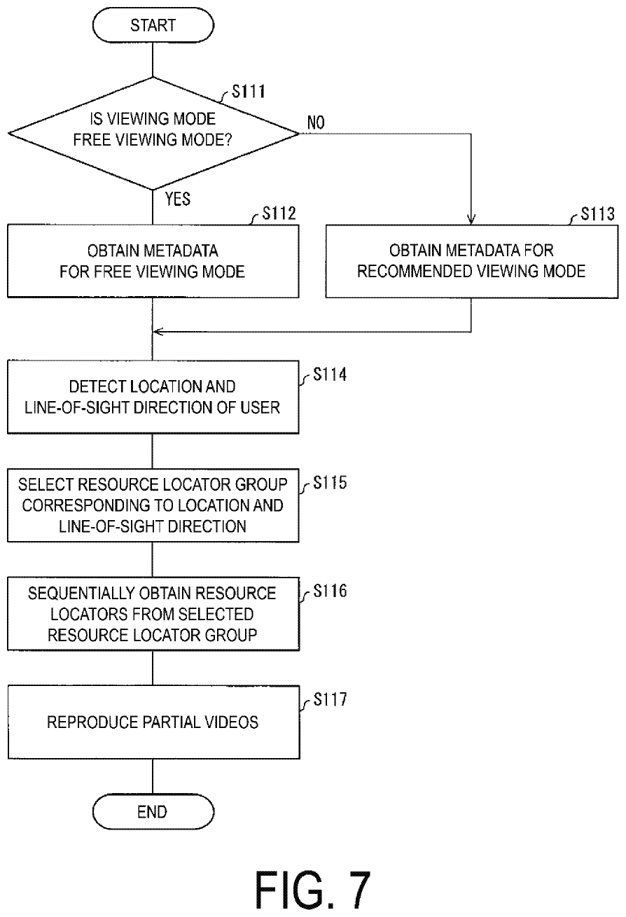

Now, reproduction processing (a reproduction method) of the reproduction device 100 of the reproduction system 1 according to the present embodiment will be described with reference to FIG. 7. FIG. 7 is a flowchart illustrating a flow of the reproduction processing of the reproduction device 100 of the reproduction system 1 according to the present embodiment.

Step S11: As illustrated in FIG. 7, the controller 110 of the reproduction device 100 first determines whether to select the free viewing mode or the recommended viewing mode. Selection of the free viewing mode (step S111, YES) causes the processing to proceed to step S112. Selection of the recommended viewing mode (step S111, NO) causes the processing to proceed to step S113.

Step S112: Selection of the free viewing mode causes the first obtaining unit 1100 in the controller 110 of the reproduction device 100 to request metadata for the free viewing mode to the generation device 300. Subsequently, the first obtaining unit 1100 of the reproduction device 100 obtains, from the generation device 300, metadata for the free viewing mode including the multiple resource locator groups (first obtaining step).

Step S113: Selection of the recommended viewing mode causes the first obtaining unit 1100 in the controller 110 of the reproduction device 100 to request metadata for the recommended viewing mode to the generation device 300. Subsequently, the first obtaining unit 1100 of the reproduction device 100 obtains, from the generation device 300, metadata for the recommended viewing mode including the multiple resource locator groups (first obtaining step).

Step S114: The second obtaining unit 1110 of the reproduction device 100 first detects the location and line-of-sight direction of the user. The location and line-of-sight direction of the user can be detected by a known location information obtaining unit such as any of a GPS and various sensors.

Step S115: The second obtaining unit 1110 of the reproduction device 100 then selects, from one or more resource locator groups, a resource locator group corresponding to the location and line-of-sight direction of the user.

Step S116: The second obtaining unit 1110 of the reproduction device 100 sequentially references the resource locators in the selected resource locator group to obtain the partial video data (second obtaining step).

For example, as illustrated in FIG. 3, the first obtaining unit 1100 is assumed to have obtained the time division data Period 5a for the free viewing mode at times t1 to t2 in MPD data 5. In this case, the second obtaining unit 1110 references the Segments 500a, . . . , 500n in order in the AdaptationSet 50a to request the partial video data. Accordingly, the second obtaining unit 1110 sequentially obtains the partial video data 5000a, . . . , 5000n from the Segment.

Here, as illustrated in FIG. 3, the second obtaining unit 1110 is assumed to have obtained the partial video data related to the 360 video at times t1 to t2. It is also assumed that, at time t2, the generation device 300 delivers the Period 5b related to the extended 360 video. In this case, the controller 110 of the reproduction device 100 may cause the display unit 150 to display a message such as an “Extended 360 video” available. Accordingly, the controller 110 of the reproduction device 100 can notify the user of a change in video type. As a result, the reproduction device 100 can cause the user to more preferably view the omnidirectional video.

Step S117: The reproduction unit 120 of the reproduction device 100 reproduces the partial video data obtained by the second obtaining unit 1110 (reproduction step). In a case that a prescribed time has passed since the end of the reproduction, the reproduction unit 120 of the reproduction device 100 terminates the reproduce process.

The reproduction device 100 performs the steps S114 to S117 described above in a prescribed unit of time. For example, the reproduction device 100 performs the steps S114 to S117 in units of each of the periods 5a and 5b illustrated in FIGS. 3 and 4.

### Embodiment 2

In Embodiment 1, the reproduction device 100 of the reproduction system 1 constantly reproduces the partial videos in the free viewing mode or the recommended viewing mode. However, like a reproduction device 600 of a reproduction system 2 according to Embodiment 2, the reproduction device may switch between the free viewing mode and the recommended viewing mode to reproduce the partial video.

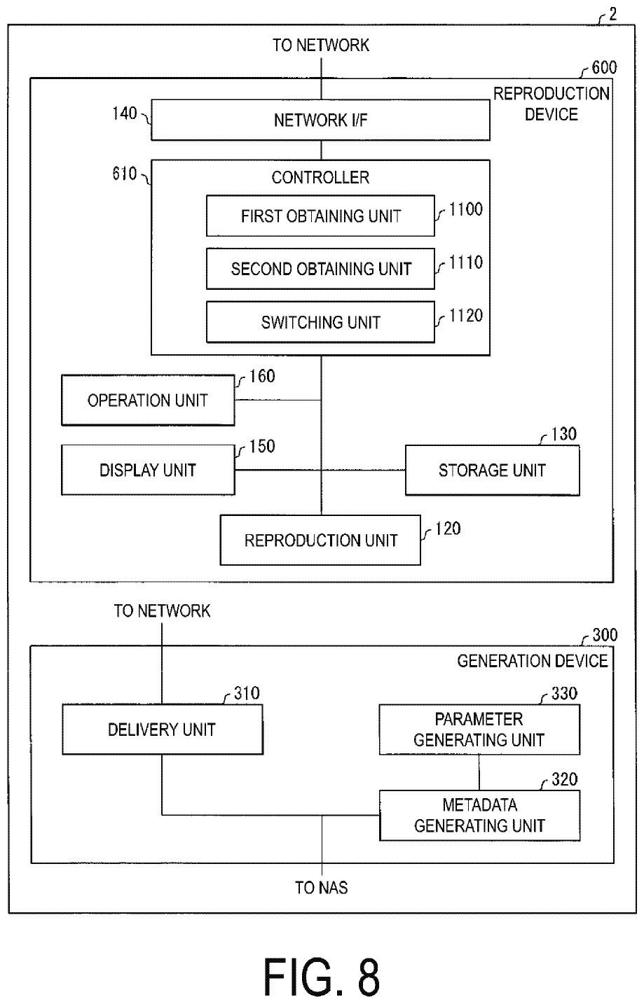

Embodiment 2 will be described with reference to FIGS. 8 to 13. For the sake of convenience of description, members providing the same functions as the members described in Embodiment 1 are denoted by the same reference signs, and descriptions of the members are omitted.

### Reproduction System 2

FIG. 8 is a block diagram illustrating a configuration of a main part of the reproduction system 2 according to the present embodiment. As illustrated in FIG. 8, a controller 610 of the reproduction device 600 of the reproduction system 2 according to the present embodiment functions not only as each member of the controller 110 but also as a switching unit 1120. Otherwise the reproduction device 600 is configured similarly to the reproduction device 100.

### Reproduction Device 600

As illustrated in FIG. 8, the reproduction device 600 includes the controller 610.

The controller 610 functions as the switching unit 1120. The switching unit 1120 switches between the free viewing mode and the recommended viewing mode. In this case, the switching unit 1120 may switch from the free viewing mode to the recommended viewing mode or from the recommended viewing mode to the free viewing mode.

The reproduction device 600 includes the switching unit 1120 and can thus switch the viewing mode without depending on which of the 360 video and the extended 360 video is to be reproduced. Thus, the reproduction device 600 can reproduce the 360 video or the extended 360 video in a timely and suitable viewing mode.

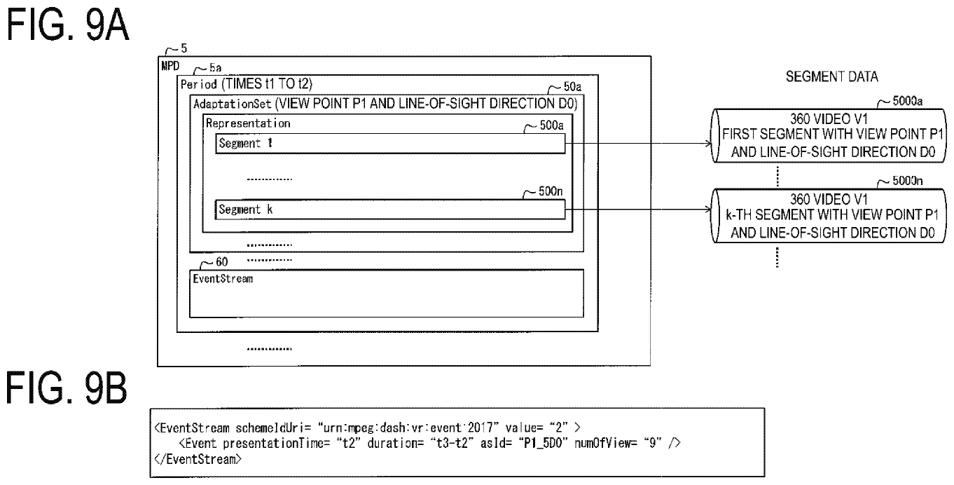

Hereinafter, switching of the viewing mode by the switching unit 1120 will be more specifically described using FIGS. 9 to 11.

### Specific Example 1 of Switching of Viewing Mode by Switching Unit 1120

First, a specific example of switching the viewing mode by the switching unit 1120 will be described using FIGS. 9A and 9B.

FIGS. 9A and 9B are diagrams illustrating an example of metadata related to the switching of the viewing mode included in the metadata referenced by the switching unit 1120 of the reproduction device 600.

The metadata in FIG. 9A differs from the metadata in FIG. 3 in that EventStream 60 is added. That is, the reproduction device 600 receives the metadata in FIG. 9A and can reproduce the 360 video in the recommended viewing mode. However, in FIG. 9A, some of the elements in FIG. 3 such as the AdaptationSet 51a and the Period 5b are omitted.

FIG. 9B is a diagram illustrating a specific example of the EventStream 60. The EventStream 60 can describe events such as a 360 video delivery start event and an extended 360 video delivery start event. The type of the event described in the EventStream 60 is identified by a value of a value attribute of an EventStream element.

The meaning of each value described in the value attribute is defined by a URI indicated by a scheme_id_uri attribute of the EventStream element.

For example, for scheme_id_uri=“urn: mpeg: dash: vr: event: 2017” illustrated in FIG. 9B, value=“1” means the 360 video delivery start event and value=“2” means the extended 360 video delivery start event.

Changing the value described in the value attribute of the EventStream 60 allows the switching unit 1120 to switch not only the viewing mode but also the video type.

The details of the 360 video delivery start event and the extended 360 video delivery start event are described by an Event element in the EventStream element. A presentation Time attribute of the Event element indicates a delivery start time for the 360 video/extended 360 video. A duration attribute of the Event element indicates a delivery period for the 360 video/extended 360 video. A num Of View attribute of the Event element indicates the number of view points in the extended 360 video. Although not illustrated, a view Range attribute may be described that indicates the range of view points (e.g., the range of movable view points is 1 m around) in the extended 360 video. Note that, for the 360 video delivery start event (value=“1”), the num Of View attribute and the view Range attribute may be omitted.

The example in FIG. 9B indicates that an extended 360 video with nine view points is delivered for a period from time t2 to time t3.

In a case of reproducing, in the free viewing mode, partial videos of the extended 360 video started at time t2, the reproduction device 600 obtains MPD data for the free viewing mode from the generation device 300 at the appropriate timing based on EventStream 60. This allows switching from the recommended viewing mode to the free viewing mode.

Note that, in the example described above, the EventStream 60 is added at the timing of initial obtainment of the MPD data for the recommended viewing mode. However, in live delivery and the like, a DASH MPD update scheme may be used to, for example, obtain the MPD data with the EventStream 60 being added at the timing of MPD update immediately before time t2.

### Specific Example 2 of Switching of Viewing Mode by Switching Unit 1120

In the example described above, the switching unit 1120 switches the viewing mode with reference to EventStream 60. However, the present embodiment is not limited thereto. In the present embodiment, the switching unit 1120 may obtain metadata related to the switching of the viewing mode from an Inband Event 70 included in the partial video data, and switch the viewing mode with reference to the obtained metadata.

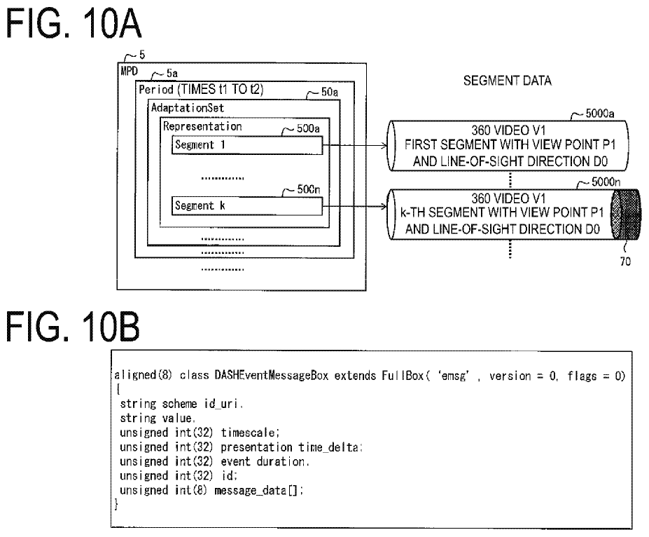

The Inband Event 70 refers to an event message box specified in the DASH. FIG. 10B is a diagram illustrating a configuration of the event message box. The Inband Event 70 is described in the fields of scheme_id_uri, value, time_scale, presentation_time_delta, event_duration, id, and message_data [ ].

Here, the definitions of scheme_id_uri and value are similar to the definitions for the EventStream 60. For scheme_id_uri=“urn: mpeg: dash: vr: event: 2017”, value=“1” means the 360 video delivery start event. value=“2” means the extended 360 video delivery start event.

In other words, as is the case with the EventStream 60, changing the value described in the value attribute of Inband Event 70 allows the switching unit 1120 to switch the video type as well as the viewing mode.

Time_scale means a time scale for the value of a time related field. presentation_time_delta describes, in the time scale described above, the value of a difference between a start time for segment data to which the Inband Event 70 is provided and the delivery start time for the 360 video or the extended 360 video. event_duration describes a delivery period for the 360 video or the extended 360 video in the time scale described above. id means an event identifier. message_data [ ] describes information indicating, for example, the ID of the AdaptationSet corresponding to the current view point and line-of-sight direction. For the extended 360 video, message_data [ ] may further describe the number of view points and the range of view points.

Hereinafter, the switching of the viewing mode by the switching unit 1120 in a case that metadata related to the switching of the viewing mode is obtained from the Inband Event 70 will be specifically described using FIGS. 10A and 10B.

FIG. 10A is a diagram illustrating an example of metadata referenced by the reproduction system 2, partial video data, and metadata related to the switching of the viewing mode included in the partial video data.

FIG. 10A differs from FIG. 3 in that the Inband Event 70 is added to the partial video data 5000n in FIG. 3. That is, the reproduction device 600 receives the metadata in FIG. 10A and can then reproduce the 360 video in the recommended viewing mode. Note that, in FIG. 10A, some elements in FIG. 3 such as the AdaptationSet 51a and the Period 5b are omitted.

In the example in FIG. 10A, the partial video data 5000n indicated by the Segment 500n includes the Inband Event 70 indicating that an extended 360 video with nine view points is delivered for a period from time t2 to time t3 as in the case of EventStream 60.

In a case of reproducing, in the free viewing mode, the extended 360 video starting at time t2, the reproduction device 600 obtains MPD data for the free viewing mode from the generation device 300 at an appropriate timing based on Inband Event 70. In this way, the switching unit 1120 of the reproduction device 600 can switch from the recommended viewing mode to the free viewing mode at the appropriate timing.

The Inband Event 70 is configured to multiplex the metadata related to the switching of the viewing mode into the partial video data. Thus, even in a case that, in live delivery or the like, the type of the video to be delivered is not known until immediately before the start of the delivery, the switching unit 1120 of the reproduction device 600 can obtain the Inband Event 70 at the appropriate timing. In this way, the switching unit 1120 of the reproduction device 600 can switch the viewing mode at the appropriate timing.

### Specific Example 3 of Switching of Viewing Mode by Switching Unit 1120

The switching unit 1120 may obtain metadata related to the switching of the viewing mode from the Supplemental Enhanced Information (SEI) included in the partial video data. The switching unit 1120 may reference the metadata and switch the viewing mode.

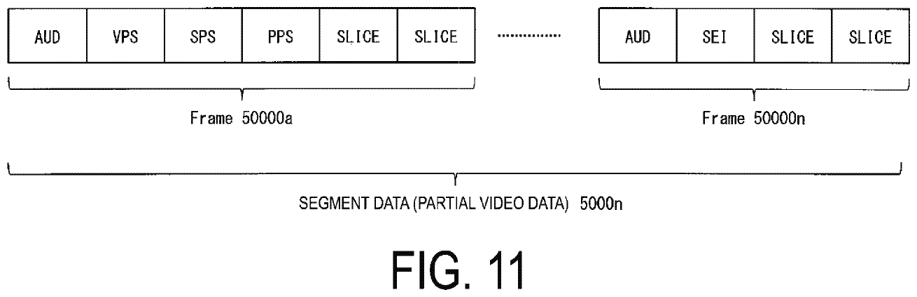

Hereinafter, the switching of the viewing mode by the switching unit 1120 in a case that metadata related to the switching of the viewing mode is obtained from SEI will be specifically described with reference to FIG. 11.

FIG. 11 is a diagram illustrating an example of metadata related to the switching of the viewing mode included in the metadata referenced by the reproduction system 2, and also illustrates segment data of a NAL configuration.

Here, “NAL” refers to a layer provided to abstract communication between a Video Coding Layer (VCL) that is a layer for video coding processing and a lower layer system for transmitting and accumulating coded data.

AUD means an access unit delimiter. The AUD indicates the start of one Frame such as a Frame 50000a.

VPS refers to a video parameter set. The VPS is a parameter set for specifying parameters common to multiple Frames. The VPS specifies a set of coding parameters common to multiple partial videos each including multiple layers, and a set of coding parameters associated with the multiple layers included in the partial video and the individual layers.

SPS refers to a sequence parameter set. The SPS specifies a set of coding parameters for decoding the Frame 50000a. For example, the SPS specifies the width and height of a picture.

PPS refers to a picture parameter set. The PPS specifies a set of coding parameters for decoding each of the pictures in the Frame 50000a.

SLICE refers to a slice layer. The SLICE specifies a set of data for decoding a slice to be processed.

In the present embodiment, SEI in FIG. 11 describes metadata equivalent to the EventStream 60 and Inband Event 70 described above. As can be seen in FIG. 11, the SEI is included in a Frame 50000n that is one of the Frames constituting the segment data 5000n. Thus, the switching unit 1120 can obtain, at a timing adjusted more precisely than for the Inband Event 70, metadata related to the switching of the viewing mode from the SEI in the Frame 50000n of the segment data 5000n as illustrated in FIG. 11.

In a case of reproducing, in the free viewing mode, the extended 360 video started at time t2, the reproduction device 600 obtains MPD data for the free viewing mode from the generation device 300 at the appropriate timing, based on SEI described above. In this way, the switching unit 1120 of the reproduction device 600 can switch from the recommended viewing mode to the free viewing mode at the appropriate timing.

Note that the switching unit 1120 can switch the video type as well as the viewing mode using the SEI.

### Metadata Generation Processing Related to Switching of Video Type

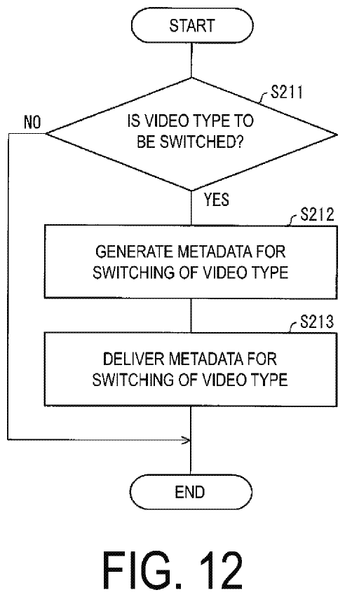

Now, generation processing of the generation device 300 of the reproduction system 2 according to the present embodiment will be described with reference to FIG. 12. FIG. 12 is a flowchart illustrating a flow of generation processing related to the switching of the video type and executed by the generation device 300 of the reproduction system 2 according to the present embodiment.

Description will be given below of the generation processing related to the switching of the video type in a case that the reproduction system 2 utilizes metadata such as the EventStream 60, the Inband Event 70, or the SEI.

Step S211: As illustrated in FIG. 12, in a case that the metadata generating unit 320 of the generation device 300 switches the video type (step S211, YES), the processing proceeds to step S212. In a case that the metadata generating unit 320 of the generation device 300 does not switch the video type (step S211, NO), the metadata generation processing related to the switching of the viewing mode is terminated.

Step S212: The metadata generating unit 320 of the generation device 300 generates metadata for the switching of the video type.

For example, the metadata generating unit 320 of the generation device 300 generates metadata such as the EventStream 60, the Inband Event 70, and the SEI.

Step S213: In a case that the EventStream 60 is utilized as metadata for switching of the video type, the metadata generating unit 320 of the generation device 300 provides EventStream 60 to metadata such as the MPD data generated separately from the metadata. Subsequently, the delivery unit 310 of the generation device 300 delivers, to the reproduction device 600, metadata such as MPD data to which the EventStream 60 has been provided.

In a case that the Inband Event 70 is utilized as metadata for the switching of the video type, the metadata generating unit 320 of the generation device 300 provides the metadata for the switching of the video type into segment data in a multiplexing manner. Subsequently, the delivery unit 310 of the generation device 300 delivers, to the reproduction device 600, the segment data to which the Inband Event 70 has been provided.

In a case that the SEI is utilized as metadata for the switching of the video type, the metadata generating unit 320 of the generation device 300 provides the metadata for the switching of the video type to the SEI in the segment data in a multiplexing manner.

Subsequently, the delivery unit 310 of the generation device 300 delivers, to the reproduction device 600, the segment data to which the SEI has been provided.

The generation device 300 terminates the metadata generation processing related to the switching of the viewing mode after delivery of the metadata such as the MPD data or the segment data to which the metadata for switching of the video type has been provided.

The metadata generating unit 320 of the generation device 300 performs each of the steps S211 to S213 described above for each delivery unit of the segment data.

### Reproduction Processing

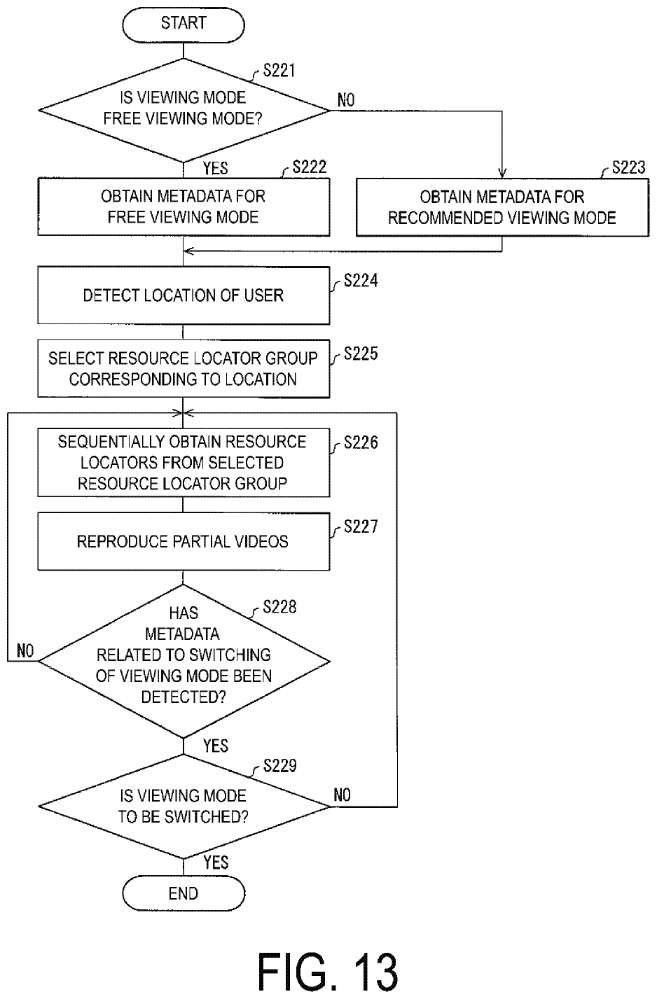

Now, reproduction processing (reproduction method) of the reproduction device 600 of the reproduction system 2 according to the present embodiment will be described with reference to FIG. 13. FIG. 13 is a flowchart illustrating a flow of the reproduction processing of the reproduction device 600 of the reproduction system 2 according to the present embodiment.

Steps S221 to S227 in FIG. 13 are similar to the steps S11 to S117 in FIG. 7, and thus, the description of these steps is omitted.

Step S228: In a case that the second obtaining unit 1110 of the reproduction device 600 has obtained the resource locators from the resource locator groups, the switching unit 1120 of the reproduction device 600 searches the MPD data or the segment data for the metadata related to switching of the viewing mode. In a case that the switching unit 1120 of the reproduction device 600 detects the metadata related to the switching in the MPD data or the segment data (step S228, YES), then the processing proceeds to step S229. In a case that the switching unit 1120 of the reproduction device 600 fails to detect the metadata related to the switching in the MPD data or the segment data (step S228, NO), then the processing returns to step S226.

For example, the second obtaining unit 1110 of the reproduction device 600 detects the EventStream 60 in the Period 5a as illustrated in FIGS. 9A and 9B. The second obtaining unit 1110 of the reproduction device 600 detects the Inband Event 70 or the SEI in the segment data 5000n as illustrated in FIGS. 10A and 10B, and FIG. 11.

Step S229: In a case that the switching unit 1120 of the reproduction device 600 selects to switch the viewing mode (step S229, YES), the generation processing is terminated. In this case, the switching unit 1120 of the reproduction device 600 requests the generation device 300 to generate MPD data for another viewing mode so as to allow obtainment, in the next and subsequent processing, of time division data for which the current viewing mode has been switched to the another viewing mode. In a case that the switching unit 1120 selects not to switch the viewing mode (step S229, NO), the processing returns to step S226.

In this way, the second obtaining unit 1110 of the reproduction device 600 can allows the user to view the partial videos in the viewing mode after the switch.

The reproduction device 600 performs the steps S224 to S229 described above in a prescribed unit of time. For example, the reproduction device 600 performs the step S224 to S229 in units of each of the periods 5a and 5b illustrated in FIG. 4.

### Embodiment 3

The reproduction systems 1 and 2 of Embodiments 1 and 2 select and reproduce the 360 video or extended 360 video captured from a single view point (single view) by one camera but are not limited to such. The reproduction system, like a reproduction system 3 of the present embodiment, may reproduce a 360 video or an extended 360 video reflecting partial videos captured from multiple view points (multi-view).

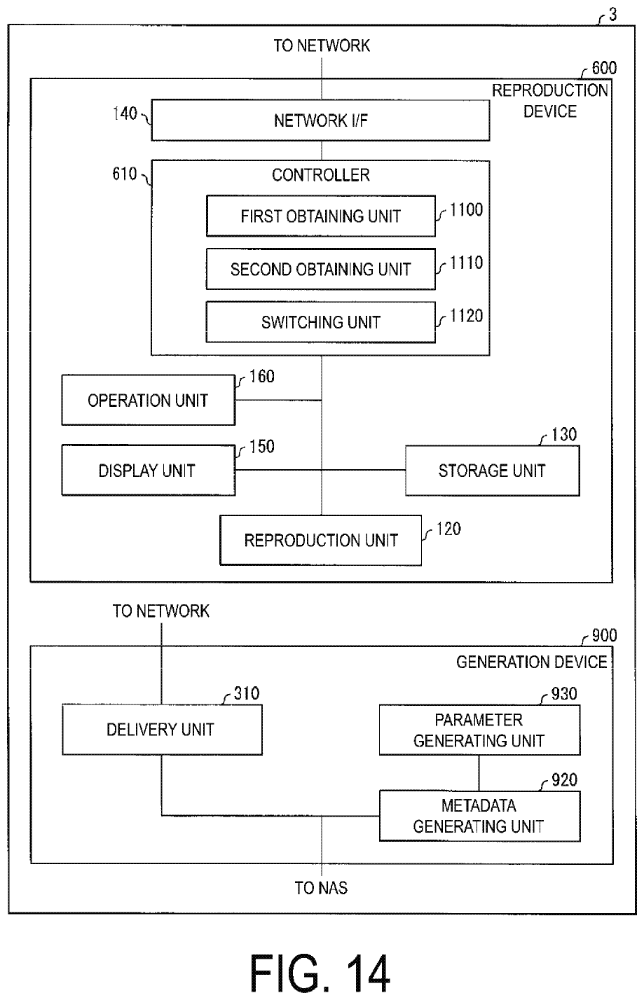

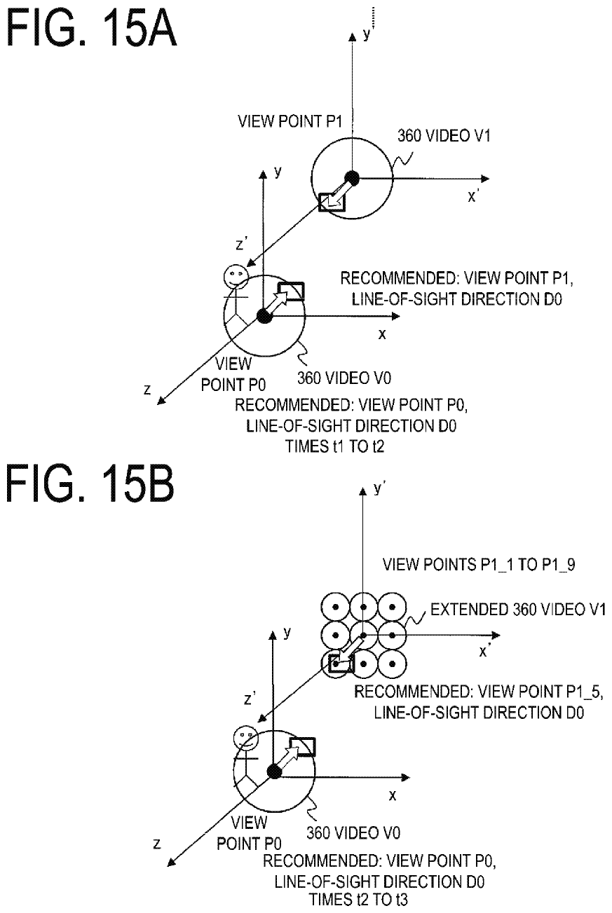

Embodiment 3 will be described with reference to FIG. 14 and FIGS. 15A and 15B. For the sake of convenience of description, members providing the same functions as the members described in Embodiments 1 and 2 are denoted by the same reference signs, and descriptions of these members are omitted.

### Reproduction System 3

FIG. 14 is a block diagram illustrating a configuration of a main part of the reproduction system 3 according to the present embodiment. The reproduction system 3 includes a reproduction device 600 and a generation device 900.

As illustrated in FIG. 14, the generation device 900 of the reproduction system 3 according to the present embodiment includes a metadata generating unit 920 and a parameter generating unit 930 instead of the metadata generating unit 320 and the parameter generating unit 330. Otherwise the generation device 900 is configured similarly to the generation device 300.

The functions of the reproduction system 3 will be described below using specific examples.

Functions of Reproduction System 3 for Case in which Camera is Fixed

First, a case that a camera with a view point P1 and a camera with a view point P0 are fixed will be described using FIGS. 15A and 15B.

The metadata generating unit 920 of the generation device 900 generates metadata including multiple resource locator groups including resource locators specifying the locations of partial video data included in each partial video data group captured from the view point P0 and the view point P1.

Here, the metadata generating unit 920 causes the parameter generating unit 930 to further generate global location information such as GPS information including the view point P0 and the view point P1, and provides the location information to metadata such as the MPD data. Thus, the metadata generating unit 920 can clearly determine a relative location relationship between the view point P0 and the view point P1, and distinguish the locations of the view points from each other. This allows the metadata generating unit 920 to distinguish between a resource locator group that indicates the location of the partial video data captured from the view point P0 from the resource locator group that indicates the location of the partial video data captured from the view point P1, and to generate the metadata.

The second obtaining unit 1110 of the reproduction device 600 can obtain the partial video data from P0 and the partial video data from P1 without mixing with reference to the resource locator group of the metadata. In this way, even in a case that partial videos have been captured by multiple cameras, the reproduction unit 120 of the reproduction device 600 can accurately reproduce the partial videos captured by these cameras, for each of the view points and line-of-sight directions of the user.

The reproduction system 3 is assumed to have switched the camera with the view point P1 from the 360 video V1 to the extended 360 video V1 at times t2 to t3, as illustrated in FIG. 15B. Also in this case, the metadata generating unit 920 can generate metadata similarly to the embodiments described above except that the global location information is provided to the metadata.

Functions of Reproduction System 3 for Case in which Camera Moves

In a case that the cameras move, the metadata generating unit 920 of the reproduction system 3 delivers global location information including the view point P0 and the view point P1, to the reproduction device 600 as timed metadata. The metadata generating unit 920 of the reproduction system 3 causes the parameter generating unit 330 to generate an identifier for identifying timed metadata to be referenced by the resource locator group (AdaptationSet) for each view point and each line-of-sight direction.

In this way, the metadata generating unit 920 of the reproduction system 3 can create metadata while distinguishing resource locator groups provided by the multiple cameras from one another, even in a case that the cameras move.

### Implementation Examples by Software

Control blocks of the reproduction devices 100 and 600 and the generation devices 300 and 900 (particularly the controllers 110 and 610 and the metadata generating units 320 and 920) may be implemented by a logic circuit (hardware) formed as an integrated circuit (IC chip) or the like, or by software using a Central Processing Unit (CPU).

In the latter case, the reproduction devices 100 and 600 and the generation devices 300 and 900 include a CPU performing instructions of a program that is software implementing the functions, a Read Only Memory (ROM) or a storage device (these are referred to as “recording media”) in which the program and various data are stored to be readable by a computer (or CPU), a Random Access Memory (RAM) in which the program is deployed, and the like. The computer (or CPU) reads from the recording medium and performs the program to achieve the object of the present invention. As the above-described recording medium, a “non-transitory tangible medium” such as a tape, a disk, a card, a semiconductor memory, and a programmable logic circuit can be used. The above-described program may be supplied to the above-described computer via an optional transmission medium (such as a communication network and a broadcast wave) capable of transmitting the program. Note that one aspect of the present invention may also be implemented in a form of a data signal embedded in a carrier wave in which the program is embodied by electronic transmission.

### Supplement

A reproduction device (100, 600) according to Aspect 1 of the present invention is a reproduction device (100, 600) for reproducing content data to be time-divided into multiple pieces of time division data (Periods 5a, 5b) for delivery, the multiple pieces of time division data (Periods 5a, 5b) including one or more partial video data groups, each of the one or more partial video data groups including a piece of partial video data at least either for a view point or for a line-of-sight direction, the piece of partial video data being a part of multiple pieces of partial video data (5000a, 5000n, 5100a, 5100n, 5000b, 5100b, 5500b, 5900b) constituting an omnidirectional video, the reproduction device (100, 600) including a first obtaining unit (1100) configured to obtain metadata (MPD data 5, 6) including multiple resource locator groups (AdaptationSets 50a, 51a, 50b, 51b, 55b, 59b), each of the multiple resource locator groups including a resource locator (Segments 500a, 500n, 510a, 510n, 500b, 510b, 550b, 590b) for specifying a location of each of the multiple pieces of partial video data (5000a, 5000n, 5100a, 5100n, 5000b, 5100b, 5500b, 5900b) included in the one or more partial video data groups, a second obtaining unit (1110) configured to obtain each of the multiple pieces of partial video data (5000a, 5000n, 5100a, 5100n, 5000b, 5100b, 5500b, 5900b) from the location indicated by the metadata (MPD data 5, 6), and a reproduction unit (120) configured to reproduce a partial video indicated by each of the multiple pieces of partial video data (5000a, 5000n, 5100a, 5100n, 5000b, 5100b, 5500b, 5900b) obtained by the second obtaining unit (1110).

According to the above-described configuration, the reproduction device (100, 600) includes the first obtaining unit (1100), the second obtaining unit (1110), and the reproduction unit (120), and can thus reproduce the omnidirectional video, based on the metadata related to the omnidirectional video.

The reproduction device (100, 600) according to Aspect 2 of the present invention corresponds to Aspect 1 described above, wherein each of the multiple resource locator groups (AdaptationSets 50a, 51a, 50b, 51b, 55b, 59b) may include no resource locator (Segments 500a, 500n, 510a, 510n, 500b, 510b, 550n, 590b) corresponding to a view point or a line-of-sight direction identical to a view point or a line-of-sight direction for the resource locator (Segments 500a, 500n, 510a, 510n, 500b, 510b, 550n, 590b) included in other resource locator groups (AdaptationSets 50a, 51a, 50b, 51b, 55b, 59b).

According to the configuration described above, the reproduction device (100, 600) can reproduce partial videos in the first reproduction mode (free viewing mode).

The reproduction device (100, 600) according to Aspect 3 of the present invention corresponds to Aspect 1 described above, wherein any (AdaptationSets 50a, 51a, 50b, 5 b, 55b, 59b) of the multiple resource locator groups (AdaptationSets 50a, 51a, 50b, 5 b, 55b, 59b) may include the resource locator (Segments 500a, 500n, 510a, 510n, 500b, 510b, 550n, 590b) corresponding to a view point or a line-of-sight direction identical to a view point or a line-of-sight direction for the resource locator (Segments 500a, 500n, 510a, 510n, 500b, 510b, 550n, 590b) included in any (AdaptationSets 50a, 51a, 50b, 51b, 55b, 59b) of other resource locator groups (AdaptationSets 50a, 51a, 50b, 51b, 55b, 59b).

According to the configuration above, the reproduction device (100, 600) can reproduce the partial videos in the second reproduction mode (the recommended viewing mode).

The reproduction device (100, 600) according to Aspect 4 of the present invention corresponds to any one of Aspects 1 to 3 described above, wherein the partial videos included in each of the multiple pieces of time division data (Periods 5a, 5b) may be a media segment specified in Dynamic Adaptive Streaming over HTTP (DASH), the metadata (MPD data 5, 6) may be MPD data specified in the DASH and related to the content data, the resource locator (Segments 500a, 500n, 510a, 510n, 500b, 510b, 550n, 590b) may be a URL of the media segment, and each of the multiple resource locator groups (AdaptationSets 50a, 51a, 50b, 51b, 55b, 59b) may be an AdaptationSet specified in the DASH.

Each partial video included in the time division data (Periods 5a, 5b) can be preferably utilized as a media segment specified in the Dynamic Adaptive Streaming over HTTP (DASH). The metadata (MPD data 5, 6) can be preferably utilized as MPD data specified in the DASH and related to the content data. The resource locators (Segments 500a, 500n, 510a, 510n, 500b, 510b, 550n, 590b) can be preferably utilized as URLs of the media segments. Each of the resource locator groups (AdaptationSets 50a, 51 a, 50b, 51b, 55b, 59b) can be preferably utilized as an AdaptationSet specified in the DASH.

The reproduction device (100, 600) according to Aspect 5 of the present invention corresponds to Aspect 4 described above, wherein the first obtaining unit (1100) may obtain a parameter group including the view point and line-of-sight direction for each partial video from a SupplementalDescriptor or an EssentialDescriptor included in each of a plurality of the AdaptationSets.

The first obtaining unit (1100) can preferably obtain the parameter group including the view point and line-of-sight direction for each partial video from the Supplemental Descriptor or EssentialDescriptor included in each of the AdaptationSets.

The reproduction device (100, 600) according to Aspect 6 of the present invention corresponds to Aspect 5 described above, wherein the first obtaining unit (1100) may obtain the parameter group related to a recommended view point and a recommended line-of-sight direction from the SupplementalDescriptor.

The first obtaining unit (1100) can preferably obtain the parameter group related to the recommended view point and line-of-sight direction from the SupplementalDescriptor.

(600) according to Aspect 7 of the present invention corresponds to any one of Aspects 4 to 6 described above, may further include a switching unit (1120) configured to switch between a first reproduction mode (free viewing mode) for referencing the metadata (MPD data 5) in which each of the multiple resource locator groups (AdaptationSets 50a, 51a, 50b, 51b, 55b, 59b) includes no resource locators (Segments 500a, 500n, 510a, 510n, 500b, 510b, 550n, 590b) corresponding to a view point or a line-of-sight direction identical to a view point or a line-of-sight direction for the resource locator (Segments 500a, 500n, 510a, 510n, 500b, 510b, 550n, 590b) included in other resource locator groups (AdaptationSets 50a, 51a, 50b, 51b, 55b, 59b) and a second reproduction mode (recommended viewing mode) for referencing the metadata (MPD data 6) in which any of the multiple resource locator groups (AdaptationSets 50a, 51a, 50b, 51b, 55b, 59b) includes the resource locator (Segments 500a, 500n, 510a, 510n, 500b, 510b, 550n, 590b) corresponding to a view point or a line-of-sight direction identical to a view point or a line-of-sight direction for the resource locator (Segments 500a, 500n, 510a, 510n, 500b, 510b, 550n, 590b) included in the other resource locator groups (AdaptationSets 50a, 51a, 50b, 51b, 55b, 59b).

According to the configuration described above, the reproduction device (600) includes the switching unit (1120) and can thus switch the reproduction mode independently of which of the 360 video and the extended 360 video is to be reproduced. Thus, the reproduction device (600) can reproduce the partial videos of the 360 video or the extended 360 video in a timely and suitable reproduction mode.

(600) according to Aspect 8 of the present invention corresponds to Aspect 7 described above, wherein the switching unit (1120) may obtain the metadata related to switching of a reproduction mode from an EventStream (60) included in the MPD data, and switch the reproduction mode with reference to the metadata obtained.

The switching unit (1120) of the reproduction device (600) can preferably utilize the EventStream (60) to switch the reproduction mode.

The reproduction device (600) according to Aspect 9 of the present invention corresponds to Aspect 7 described above, wherein the switching unit (1120) may obtain the metadata related to switching of a reproduction mode from an Inband Event (70) included in the piece of partial video data (5000a, 5000n, 5100a, 5100n, 5000b, 5100b, 5500b, 5900b), and switch the reproduction mode with reference to the metadata obtained.

The switching unit (1120) of the reproduction device (600) may preferably utilize the Inband Event (70) to switch the reproduction mode.

The reproduction device (600) according to Aspect 10 of the present invention corresponds to Aspect 7 described above, wherein the switching unit (1120) may obtain the metadata related to switching of a reproduction mode from SupplementalEnhanced Information (SEI) included in the piece of partial video data (5000a, 5000n, 5100a, 5100n, 5000b, 5100b, 5500b, 5900b), and switch the reproduction mode with reference to the metadata obtained.

The switching unit (1120) of the reproduction device (600) can preferably utilize the SEI to switch the reproduction mode.

A generation device (300, 900) according to Aspect 11 of the invention is a generation device (300, 900) generating metadata (MPD data 5, 6) to be referenced by a reproduction device (100, 600) for reproducing content data to be time-divided into multiple pieces of time division data (Periods 5a, 5b) for delivery, the multiple pieces of time division data (Periods 5a, 5b) including one or more partial video data groups, each of the one or more partial video data groups including a piece of partial video data (5000a, 5000n, 5100a, 5100n, 5000b, 5100b, 5500b, 5900b) at least either for a view point or for a line-of-sight direction, the piece of partial video data being a part of multiple pieces of partial video data (5000a, 5000n, 5100a, 5100n, 5000b, 5100b, 500b, 5900b) constituting an omnidirectional video, the generation device (300, 900) including a metadata generating unit (320, 920) configured to generate the metadata (MPD data 5, 6) including multiple resource locator groups (AdaptationSets 50a, 51a, 50b, 51b, 55b, 59b), each of the multiple resource locator groups including a resource locator (Segments 500a, 500n, 510a, 510n, 500b, 510b, 550n, 590b) for specifying a location of each of the multiple pieces of partial video data (5000a, 5000n, 5100a, 5100n, 5000b, 5100b, 5500b, 5900b) included in the one or more partial video data groups.

According to the configuration described above, the generation device (300, 900) includes the metadata generating unit (320, 920) and can thus generate metadata related to the omnidirectional video.

The generation device (300, 900) according to Aspect 12 of the present invention corresponds to Aspect 11 described above, wherein the metadata generating unit (320, 920) may generate the metadata (MPD data 5) in which each of the multiple resource locator groups (AdaptationSets 50a, 51a, 50b, 51b, 55b, 59b) includes no resource locator (Segments 500a, 500n, 510a, 510n, 500b, 510b, 550n, 590b) corresponding to a view point or a line-of-sight direction identical to a view point or a line-of-sight direction for the resource locator (Segments 500a, 500n, 510a, 510n, 500b, 510b, 550n, 590b) included in other resource locator groups (AdaptationSets 50a, 51a, 50b, 51b, 55b, 59b).

According to the configuration described above, the generation device (300, 900) can generate metadata (MPD data 5) for reproducing the partial videos in the first reproduction mode (free viewing mode).

The generation device (300, 900) according to Aspect 13 of the present invention corresponds to Aspect 11 described above, wherein the metadata generating unit (320, 920) may generate the metadata (MPD data 6) in which any of the multiple resource locator groups (AdaptationSets 50a, 51a, 50b, 51b, 55b, 59b) includes the resource locator (Segments 500a, 500n, 510a, 510n, 500b, 510b, 550n, 590b) corresponding to a view point or a line-of-sight direction identical to a view point or a line-of-sight direction for the resource locator (Segments 500a, 500n, 510a, 510n, 500b, 510b, 550n, 590b) included in other resource locator groups (AdaptationSets 50a, 51a, 50b, 51b, 55b, 59b).

According to the configuration described above, the generation device (300, 900) can generate metadata (MPD data 6) for reproducing the partial videos in the second reproduction mode (recommended viewing mode).

A reproduction system (1, 2, 3) according to Aspect 14 of the present invention is a reproduction system (1, 2, 3) for reproducing content data to be time-divided into multiple pieces of time division data (Periods Sa, 5b) for delivery, the multiple pieces of time division data (Periods 5a, 5b) including one or more partial video data groups, each of the one or more partial video data groups including a piece of partial video data (5000a, 5000n, 5100a, 5100n, 5000b, 5100b, 5500b, 5900b) at least either for a view point or for a line-of-sight direction, the piece of partial video data being a part of multiple pieces of partial video data (5000a, 5000n, 5100a, 5100n, 5000b, 5100b, 5500b, 5900b) constituting an omnidirectional video, the reproduction system (1, 2, 3) including a metadata generating unit (320, 920) configured to generate metadata (MPD data 5, 6) including multiple resource locator groups (AdaptationSets 50a, 51a, 50b, 51b, 55b, 59b), each of the multiple resource locator groups including a resource locator (Segments 500a, 500n, 510a, 510n, 500b, 510b, 550b, 590b) for specifying a location of each of the multiple pieces of partial video data (5000a, 5000n, 5100a, 5100n, 5000b, 5100b, 5500b, 5900b) included in the one or more partial video data groups, a first obtaining unit (1100) configured to obtain the metadata (MPD data 5, 6) including the multiple resource locator groups (AdaptationSets 50a, 51a, 50b, 5 b, 55b, 59b), each of the multiple resource locator groups including the resource locator (Segments 500a, 500n, 510a, 510n, 500b, 510b, 550b, 590b) for specifying the location of each of the multiple pieces of partial video data (5000a, 5000n, 5100a, 5100n, 5000b, 5100b, 5500b, 5900b) included in the one or more partial video data groups, a second obtaining unit (1110) configured to obtain each of the multiple pieces of partial video data (5000a, 5000n, 5100a, 5100n, 5000b, 5100b, 5500b, 5900b) from the location indicated by the metadata (MPD data 5, 6), and a reproduction unit (120) configured to reproduce a partial video indicated by each of the multiple pieces of partial video data (5000a, 5000n, 5100a, 5100n, 5000b, 5100b, 5500b, 5900b) obtained by the second obtaining unit (1110).

According to the above configuration, the reproduction system (1, 2, 3) includes the reproduction device (100, 600) and the generation device (300, 900) and can thus generate and transmit metadata related to the omnidirectional video and reproduce the omnidirectional video, based on the metadata.

A program according to Aspect 15 of the present invention is a program causing a computer to operate as the reproduction device (100, 600) described in any one of Aspects 1 to 10, the program causing the computer to operate as each of the above-described units.

The program can be preferably utilized to function as each of the units of the reproduction device (100, 600).

A program according to Aspect 16 of the present invention is a program causing a computer to operate as the generation device (300, 900) described in Aspects 11 to 13 described above, the program causing the computer to operate as each of the above-described units.

The program can be preferably utilized to function as each of the above-described units of the generation device (300, 900).

A recording medium according to Aspect 17 of the present invention is a computer readable recording medium in which the program described above in Aspect 15 or 16 is recorded.

The computer readable recording medium can be preferably used for the program described above in Aspect 15 and the program described above in Aspect 16.

A reproduction method according to Aspect 18 of the present invention is a reproduction method for reproducing content data to be time-divided into multiple pieces of time division data (Periods 5a, 5b) for delivery, the multiple pieces of time division data (Periods 5a, 5b) including one or more partial video data groups, each of the one or more partial video data groups including a piece of partial video data (5000a, 5000n, 5100a, 5100n, 5000b, 5100b, 500b, 5900b) at least either for a view point or for a line-of-sight direction, the piece of partial video data being a part of multiple pieces of partial video data (5000a, 5000n, 5100a, 5100n, 5000b, 5100b, 5500b, 5900b) constituting an omnidirectional video, the reproduction method including the steps of obtaining metadata (MPD data 5, 6) including multiple resource locator groups (AdaptationSets 50a, 51 a, 50b, 51b, 55b, 59b), each of the multiple resource locator groups including a resource locator (Segments 500a, 500n, 510a, 510n, 500b, 510b, 550b, 590b) for specifying a location of each of the multiple pieces of partial video data (5000a, 5000n, 5100a, 5100n, 5000b, 5100b, 5500b, 5900b) included in the one or more partial video data groups, obtaining each of the multiple pieces of partial video data (5000a, 5000n, 5100a, 5100n, 5000b, 5100b, 5500b, 5900b) from the location indicated by the metadata (MPD data 5, 6), and reproducing a partial video indicated by each of the multiple pieces of partial video data (5000a, 5000n, 5100a, 5100n, 5000b, 5100b, 5500b, 5900b) obtained in the step of obtaining each of the multiple pieces of partial video data.

According to the above-described configuration, the reproduction method includes the steps of obtaining the metadata, obtaining the partial vide data, and reproducing the partial videos, thus allowing the omnidirectional video to be reproduced based on the metadata related to the omnidirectional video.

The present invention is not limited to each of the above-described embodiments. It is possible to make various modifications within the scope of the claims. An embodiment obtained by appropriately combining technical elements each disclosed in different embodiments falls also within the technical scope of the present invention. Furthermore, combining technical elements disclosed in the respective embodiments allows formation of a new technical feature.

### CROSS-REFERENCE OF RELATED APPLICATION

This application claims the benefit of priority to JP 2017-074534 filed on Apr. 4, 2017, which is incorporated herein by reference in its entirety.

### REFERENCE SIGNS LIST

1 to 3 Reproduction system
5, 6 MPD data (metadata)
5a, 5b Period (time division data)
50a, 51a, 50b, 51b, 55b, 59b AdaptationSet (resource locator group)
60 EventStream
70 Inband Event
500a, 500n, 510a, 5100n, 500b, 5100b, 550b, 590b Segment (resource locator)
5000a, 5000n, 5100a, 5100n, 5000b, 5100b, 5500b, 5900b Partial video data
501a, 551b SupplementalDescriptor
511a, 501b, 511b, 591b EssentialDescriptor
100, 600 Reproduction device
300, 900 Generation device
320, 920 Metadata generating unit
1100 First obtaining unit
1110 Second obtaining unit
1120 Switching unit

1. A reproduction device for reproducing content data delivered in the form of multiple pieces of time division data by time division,
the multiple pieces of time division data including one or more partial video data groups, each of the one or more partial video data groups including a piece of partial video data associated with both a view point and a line-of-sight direction, the piece of partial video data being a part of multiple pieces of partial video data constituting a 360 video or an extended 360 video,
the reproduction device comprising:
a first obtaining circuit configured to obtain metadata including multiple resource locator groups, each of the multiple resource locator groups including a resource locator for specifying a location of each of the multiple pieces of partial video data included in the one or more partial video data groups;
a second obtaining circuit configured to obtain each of the multiple pieces of partial video data from the location indicated by the metadata; and
a reproduction circuit configured to reproduce a partial video indicated by each of the multiple pieces of partial video data obtained by the second obtaining circuit.

2. The reproduction device according to claim 1, wherein
each of the multiple resource locator groups includes no resource locator corresponding to a combination of a view point and a line-of-sight direction identical to a combination of a view point and a line-of-sight direction for a resource locator included in other resource locator groups.

3. The reproduction device according to claim 1, wherein
any of the multiple resource locator groups includes a resource locator corresponding to a combination of a view point and a line-of-sight direction identical to a combination of a view point and a line-of-sight direction for a resource locator included in other resource locator groups.

4. The reproduction device according to claim 1, wherein
the partial videos included in each of the multiple pieces of time division data is a media segment specified in Dynamic Adaptive Streaming over HTTP (DASH),
the metadata is MPD data specified in the DASH and related to the content data,
the resource locator is a URL of the media segment, and
each of the multiple resource locator groups is an AdaptationSet specified in the DASH.

5. The reproduction device according to claim 4, wherein
the first obtaining circuit obtains a parameter group including the view point and line-of-sight direction for each partial video from a SupplementalDescriptor or an EssentialDescriptor included in each of a plurality of the AdaptationSet.

6. The reproduction device according to claim 5, wherein
the first obtaining circuit obtains the parameter group related to a recommended view point and a recommended line-of-sight direction from the SupplementalDescriptor.

7. The reproduction device according to claim 4, further comprising:
a switching circuit configured to switch between
a first reproduction mode for referencing the metadata in which each of the multiple resource locator groups includes no resource locator corresponding to a combination of a view point and a line-of-sight direction identical to a combination of a view point and a line-of-sight direction for a resource locator included in other resource locator groups, and
a second reproduction mode for referencing the metadata in which any of the multiple resource locator groups includes a resource locator corresponding to a combination of a view point and a line-of-sight direction identical to a combination of a view point and a line-of-sight direction for a resource locator included in the other resource locator groups.

8. The reproduction device according to claim 7, wherein
the switching circuit obtains the metadata related to switching of a reproduction mode from an EventStream included in the MPD data, and switches the reproduction mode with reference to the metadata obtained.

9. The reproduction device according to claim 7, wherein
the switching circuit obtains the metadata related to switching of a reproduction mode from an Inband Event included in the piece of partial video data, and switches the reproduction mode with reference to the metadata obtained.

10. The reproduction device according to claim 7, wherein
the switching circuit obtains the metadata related to switching of a reproduction mode from Supplemental Enhanced Information (SEI) included in the piece of partial video data, and switches the reproduction mode with reference to the metadata obtained.

11. A generation device for generating metadata to be referenced by a reproduction device for reproducing content data delivered in the form of multiple pieces of time division data by time division,
the multiple pieces of time division data including one or more partial video data groups, each of the one or more partial video data groups including a piece of partial video data associated with both a view point and a line-of-sight direction, the piece of partial video data being a part of multiple pieces of partial video data constituting a 360 video or an extended 360 video,
the generation device comprising:
a metadata generating circuit configured to generate the metadata including multiple resource locator groups, each of the multiple resource locator groups including a resource locator for specifying a location of each of the multiple pieces of partial video data included in the one or more partial video data groups.

12. The generation device according to claim 11, wherein
the metadata generating circuit generates the metadata in which each of the multiple resource locator groups includes no resource locator corresponding to a combination of a view point and a line-of-sight direction identical to a combination of a view point and a line-of-sight direction for a resource locator included in other resource locator groups.

13. The generation device according to claim 11, wherein
the metadata generating circuit generates the metadata in which any of the multiple resource locator groups includes a resource locator corresponding to a combination of a view point or a line-of-sight direction identical to a combination of a view point and a line-of-sight direction for a resource locator included in other resource locator groups.

14. A reproduction system for reproducing content data to be time-divided into multiple pieces of time division data for delivery,
the multiple pieces of time division data including one or more partial video data groups, each of the one or more partial video data groups including a piece of partial video data associated with a view point and a line-of-sight direction, the piece of partial video data being a part of multiple pieces of partial video data constituting a 360 video or an extended 360 video,
the reproduction system comprising:
a metadata generating circuit configured to generate metadata including multiple resource locator groups, each of the multiple resource locator groups including a resource locator for specifying a location of each of the multiple pieces of partial video data included in the one or more partial video data groups;
a first obtaining circuit configured to obtain the metadata including the multiple resource locator groups, each of the multiple resource locator groups including the resource locator for specifying the location of each of the multiple pieces of partial video data included in the one or more partial video data groups;
a second obtaining circuit configured to obtain each of the multiple pieces of partial video data from the location indicated by the metadata; and
a reproduction circuit configured to reproduce a partial video indicated by each of the multiple pieces of partial video data obtained by the second obtaining circuit.

15. A program causing a computer to operate as the reproduction device according to claim 1, the program causing the computer to operate as each of the circuits.

16. A program causing a computer to operate as the generation device according to any one of claim 11, the program causing the computer to operate as each of the circuits.

17. A non-transitory computer readable recording medium in which the program according to claim 15 is recorded.

18. (canceled)

19. A non-transitory computer readable recording medium in which the program according to claim 16 is recorded.
